(19) United States
(12) Patent Application Publication
(10) Pub. No.: US 2023/0286022 A1
(43) Pub. Date: Sep. 14, 2023

(54) AUTO-CLEANING METHOD FOR COLD PLANER

(71) Applicant: Caterpillar Paving Products Inc., Brooklyn Park, MN (US)

(72) Inventors: Gianfranco Perri, Bologna (IT); Nathan Louis Mashek, Albertville, MN (US)

(73) Assignee: Caterpillar Paving Products Inc., Brooklyn Park, MN (US)

(21) Appl. No.: 17/694,268

(22) Filed: Mar. 14, 2022

(51) Int. Cl. B08B 3/02; E01C 23/088

(52) U.S. Cl. CPC B08B 3/02; E01C 23/088; E01C 2301/50

(57) ABSTRACT

A cold planer, a method of programming a cleaning program, and a method of cleaning a cold planer are disclosed. The cold planer includes a drum housing, a milling drum, an intermediate stage conveyor, a final stage conveyor, a spray assembly having a plurality of spray banks, and an electronic controller configured to control each spray bank. The method of programming includes selecting one or more spray banks for activation, selecting an intensity for each activated spray bank, and selecting a mode. The method of cleaning includes selecting a cleaning program, activating one or more spray banks, and controlling a duration and a pressure and/or flowrate through each activated spray bank. The disclosed cold planer may be cleaned before and/or after a milling operation to improve operating efficiency and component life.

### TECHNICAL FIELD

The present disclosure generally relates to maintenance systems for work machines and, more specifically, to a system and method for automatically cleaning a cold planer.

### BACKGROUND

Cold planers are pavement milling machines designed to remove material from the surface of roads, bridges, parking lots, and other paved areas. Cold planers may be configured to remove an entire layer of material, such as a surface course of asphalt, or to remove a specific thickness of material. Common pavement milling operations may include recycling or reclaiming damaged asphalt, adjusting the height or camber of a road, preparing a road for the installation of curbs, manholes, catch basins, etc., and other possible applications.

During operation, milled material may accumulate on the components of the cold planer. For example, soil, asphalt, and other debris may be deposited on the milling drum, cutting elements, drum housing, conveyors, undercarriage, anti-slab, and other exposed parts. Milling operations may further generate particular matter that can settle into gears, bearings, motors, and other machinery. The accumulation of debris may wear down affected components and, if left uncleaned, lead to oxidation and rust, potentially reducing an efficiency of the cold planer and negatively affecting component life.

Within the prior art, it is common practice for an operator to clean a cold planer after each milling operation. For example, the operator may use a hose to manually spray down the affected components with water. In some prior art designs, the hose may be attached to the cold planer and may pump water from a reservoir therein. However, the manual cleaning process may be time-consuming, water inefficient, and subject to human error. In addition, certain components, such as the undercarriage of the cold planer and enclosed machinery, may be inaccessible to the operator and remain uncleaned after each use.

The state of the art has failed to provide a consistent and automated solution for cleaning a cold planer after a milling operation. One example of prior art may be found in U.S. Pat. No. 9,371,618, invented by Killion et al. and assigned to the Applicant, Caterpillar Paving Products Inc. Killion discloses a system and method for operating a cold planer, including the activation of a plurality of spray banks designed to cool, lubricate, and suppress dust during the milling process. The disclosed system includes a water reservoir, a pump, a distribution manifold, a plurality of spray banks, and an electro-mechanical flow control valve configured to activate one or more of the spray banks and maintain a desired water pressure therein. Killion further discloses a hose, a manual nozzle, and an associated low-pressure spray bank provided for discretionary cleaning by a worker.

While the system taught by Killion includes a spray assembly and control method thereof, it is configured solely for use during a milling operation of the cold planer. Killion and the prior art as a whole fail to provide for a system and method of cleaning the cold planer before or after the milling process, which may require different hardware and control processes. Furthermore, while the manual hose and nozzle disclosed by Killion may be used for cleaning purposes, they nonetheless suffer from the above-mentioned deficiencies.

Accordingly, there remains a need in the art for a system and method of cleaning a cold planer while said cold planer is not engaged in a milling operation, said method being efficient, versatile, and optionally free of manual effort.

### SUMMARY OF THE DISCLOSURE

According to a first aspect of the present disclosure, a cold planer is disclosed. The cold planer comprises a frame; a power unit being supported by the frame; a drum housing being supported by the frame; a milling drum enclosed in the drum housing and including a plurality of cutting elements; a locomotive assembly supporting the frame; an intermediate stage conveyor; a final stage conveyor; and a spray assembly configured to clean the cold planer before or after a milling operation. The spray assembly includes a reservoir, a pump, a milling drum spray bank configured to clean the milling drum, a transition spray bank configured to clean a transition area, an intermediate spray bank configured to clean the intermediate stage conveyor; and a final spray bank configured to clean the final stage conveyor. The cold planer further comprises an electronic controller configured to operatively control the pump and an activation of each spray bank.

According to a second aspect of the present disclosure, a method of programming a cleaning program for cleaning a cold planer before or after a milling operation is disclosed. The method comprises selecting one or more spray banks for activation, selecting an intensity for each activated spray bank, and selecting a mode.

According to a third aspect of the present disclosure, a method of cleaning a cold planer before or after a milling operation is disclosed. The method comprises selecting a cleaning program, activating one or more spray banks based on the cleaning program, and controlling a duration and a pressure and/or a flowrate through each activated spray bank based on the cleaning program. One or more steps of the method are operatively performed by an electronic controller.

These and other aspects and features of the present disclosure will be more readily understood after reading the following description in conjunction with the accompanying drawings.

### BRIEF DESCRIPTION OF THE DRAWINGS

FIG. 1 is an illustration of a cold planer according to one embodiment of the present disclosure.

FIG. 2 is an illustration of a perspective view of the cold planer according to another embodiment of the present disclosure.

FIG. 3 is partially fragmented view of the cold planer shown in FIG. 1.

FIG. 4 is a schematic of a cleaning system for a cold planer according to another embodiment of the present disclosure.

FIG. 5 is a flowchart depicting a method of selecting a cleaning program according to another embodiment of the present disclosure.

FIG. 6 is a flowchart depicting a method of cleaning a cold planer according to another embodiment of the present disclosure.

### DETAILED DESCRIPTION

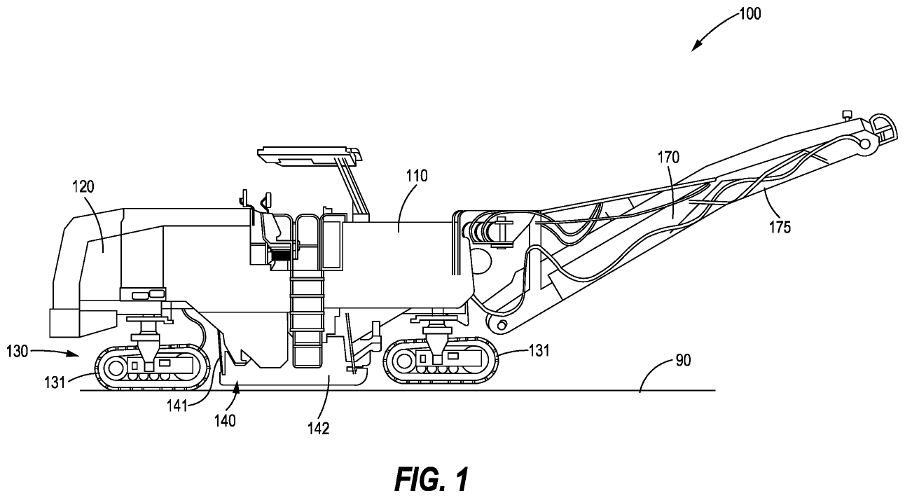

Referring now to the drawings and with specific reference to FIG. 1, an illustration of a cold planer constructed in accordance with the present disclosure is generally referred to by a reference numeral 100. The cold planer 100 is depicted as a Caterpillar PM620 ® Cold Planer for exemplary purposes, but may be any alternative and comparable cold planer or pavement milling machine. The cold planer 100 may include a frame 110, a power unit 120 being supported by the frame 110, and a locomotive assembly 130 supporting the frame 110. The locomotive assembly 130 may specifically include four ground engaging members 131, each having continuous tracks and each being operatively driven by the power unit 120. The locomotive assembly 130 may propel the cold planer 100 and, in some embodiments, may operatively adjust a height of the frame 110 and a milling depth of the cold planer 100. It may be understood that an alternative number of ground engaging members 131 and/or an alternative form of locomotive assembly 130 are also possible and envisioned.

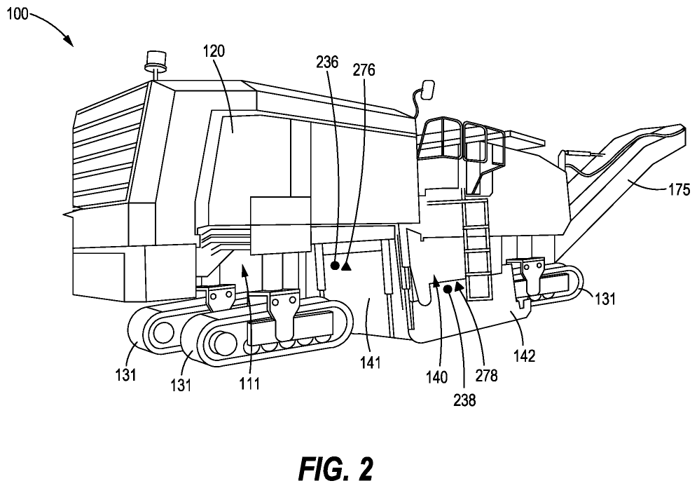

Turning now to FIG. 2, a three-quarters perspective view of the cold planer 100 is provided. As seen, the cold planer 100 may further comprise a drum housing 140 being supported by the frame and configured to enclose a milling drum 150. The drum housing 140 may include a moldboard 141 or rear door configured to provide access to the milling drum 150. The drum housing 140 may further include a side plate 142 configured to provide a reference for the milling depth of the cold planer 100.

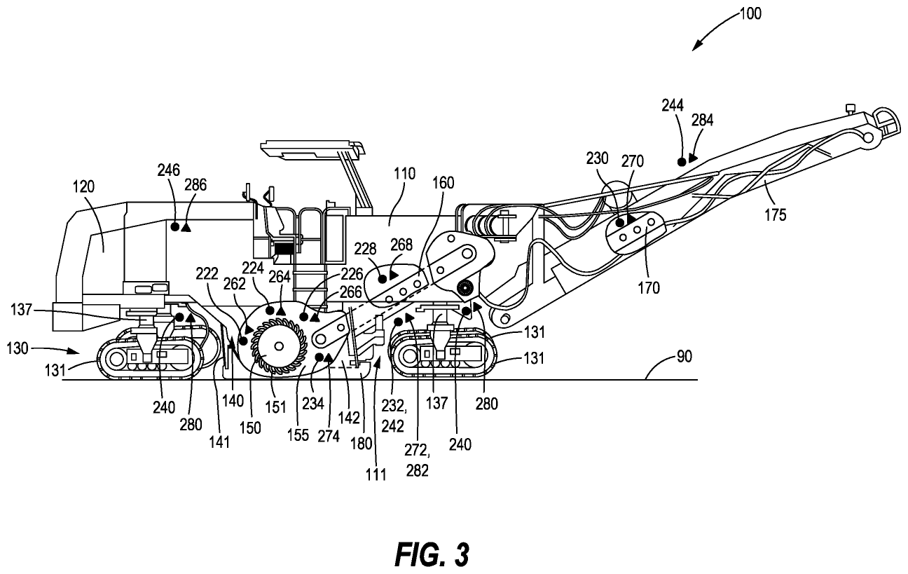

Turning now to FIG. 3, a partially fragmented view of the cold planer 100 shown in FIG. 1 is provided, which may provide a better view of several internal components of the cold planer 100. As shown in FIG. 3, the milling drum 150 may be generally cylindrical in shape, rotatably attached to the frame 110 and enclosed in the drum housing 140, and include a plurality of cutting elements 151 affixed along its circumferential surface. In some embodiments, both the drum housing 140 and the milling drum 150 may laterally extend across a width of the cold planer 100. A rotation of the milling drum 150, which may be operatively driven by the power unit 120, causes the cutting elements 151 to engage with a milling surface 90, such as a layer of asphalt, thereby penetrating and cutting away milled material. Depending on the specific machine, a milling depth of the milling drum 150 may be adjusted by a first height-adjustment mechanism (not shown) operatively connecting the milling drum 150 to the frame 110. In other embodiments, a second height-adjustment mechanism 137 may operatively connect each ground engaging member 131 to the frame 110. Furthermore, a height of the side plate 142 may be adjustable with respect to the milling drum 150 and may provide reference to the milling depth.

During operation, the milling drum 150 may rotate in a direction opposite that of the locomotive assembly 130, e.g. counterclockwise as the cold planer 100 travels rightward in FIG. 3. As the drum 150 rotates, milled material may be flung upwards across a transition area 155 and deposited onto an intermediate stage conveyor 160. More specifically, the deposited material may be transported on a belt of the intermediate stage conveyor, upwards and to the right in FIG. 3, before being deposited onto a final stage conveyor 170. Thereafter, the milled material 99 may be transported on a belt of the final stage conveyor 170 before being finally transferred from the cold planer 100 to an external location, such as a transport truck. In some embodiments, the cold planer 100 may comprise a final stage conveyor frame 175. The final stage conveyor frame 175 may be attached to and supported by the frame 110, and may support the final stage conveyor 170.

In some embodiments, each of the intermediate stage conveyor 160 and the final stage conveyor 170 may be reversible belt conveyors capable of bi-directional fixed speed applications. Each of their belts may be wrapped around respective rollers that are operatively powered by the power unit 120. It may be appreciated, however, that other configurations for the intermediate stage conveyor 160 and/or the final stage conveyor 170 are also possible and envisioned.

With continued reference to FIG. 3, the cold planer 100 may further comprise an undercarriage 111 supported by and located beneath the frame 110; and an anti-slab 180 supported by the frame 110, located beneath the transition area 155, and configured to exert a downward force on unbroken slabs of un-milled material. In some embodiments, the anti-slab 180 may further include an anti-slab height adjustment mechanism (not shown) operatively connecting the anti-slab 180 to the frame 110 and configured to adjust a height of the anti-slab 180.

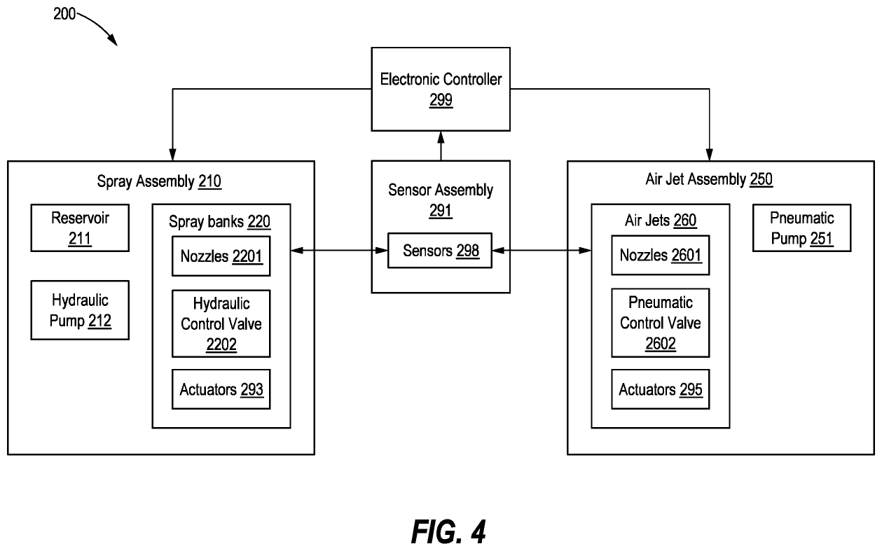

Turning now to FIG. 4, a simplified schematic of a cleaning system for the cold planer 100 is generally referred to by a reference numeral 200. The cleaning system 200 may be configured to remove dirt, soil, and other debris from one or more components of the cold planer 100 before and/or after a milling operation. In some embodiments, some features of the cleaning system 200 may overlap with an existing dust suppression system of the cold planer 100. For example, some cold planers 100 within the prior art may comprise systems of reservoirs, pumps, valves, spray banks, and other apparatuses designed to lubricate, suppress dust, and cool the cold planer 100 during milling operations. Said apparatuses may or may not be applicable to both dust suppression purposes and the cleaning functions of the present disclosure, which uniquely occur before or after the milling operation. It may also be understood that other features of the cleaning system 200 may be implemented on the cold planer 100 and function exclusively for cleaning purposes.

With continued reference to FIG. 4, the cleaning system 200 may include a spray assembly 210 configured to spray water and clean the cold planer 100 before or after a milling operation, an air jet assembly 250 configured to blast the cold planer 100 with air before or after a milling operation, and an electronic controller 299. In some embodiments of the present disclosure, the cleaning system 200 may further include a sensor assembly 291 configured to detect debris on the cold planer 100. Each of the above components which will be discussed in greater detail below.

The spray assembly 210 may specifically include a reservoir 211, a hydraulic pump 212, and a plurality of spray banks 220, each spray bank 220 being placed and configured to target one or more associated components of the cold planer 100. The reservoir 211 may be mounted on the frame 110 and configured to store a body of water. The hydraulic pump 212 may be fluidly coupled with the reservoir 211, may be fluidly coupled with each of the plurality of spray banks 220, and may operatively affect a pressure and/or a flowrate of water drawn from the reservoir 211 and supplied to each spray bank 220.

With reference now to FIG. 3, the plurality of spray banks 220 may specifically include a first milling drum spray bank 222 located inside the drum housing 140 and configured to direct a spray of water from a first direction, and thereby clean, the milling drum 150. In an embodiment, the first milling drum spray bank 222 may be located above and to the left of the milling drum 150, as viewed from FIG. 3. In the same or other embodiments, a second milling drum spray bank 224 may also be located inside the drum housing 140 and may be configured to direct a spray of water from a second direction, thereby providing additional or alternative cleansing for the milling drum 150. As viewed from FIG. 3, the second milling drum spray bank 224 may be located above and/or to the right of the milling drum 150. The plurality of spray banks 220 may include a transition spray bank 226 located inside the drum housing 140 and above the transition area 155, the transition spray bank 226 being configured to spray and clean the transition area 155. In some embodiments, each of the first milling drum spray bank 222, second milling drum spray bank 224, and transition spray bank 226 may extend laterally across a width of the cold planer 100 in a manner substantially parallel to the drum housing 140 and/or milling drum 150.

Furthermore, the plurality of spray banks 220 may include an intermediate spray bank 228 located above the intermediate stage conveyor 160 and configured to clean the intermediate stage conveyor 160, and a final spray bank 230 located above the final stage conveyor 170 and configured to clean the final stage conveyor 170.

It may be appreciated that, while the disclosed spray banks 220 are configured to associated with and target specific components of the cold planer 100, each spray bank 220 may nonetheless provide a cleaning spray to other components as well, where no limitations are intended by the present disclosure. For example, an arrangement of the first milling drum spray bank 222 and/or second milling drum spray bank 224 may be tailored to target specifically the milling drum 150 and its cutting elements 151, but may also be tailored to target and clean the drum housing 140, the transition area 155, the anti-slab 180, and/or other components of the cold planer 100 as well. Conversely, each component need not be cleaned exclusively by its associated spray bank 220.

As previously discussed, some features of the cleaning system 200 may overlap with an existing dust suppression system of the cold planer 100. Accordingly, in some embodiments, the reservoir 211, hydraulic pump 212, one or more spray banks 220, and other possible components of the cleaning system 200 may also be activated during a milling operation in order to operatively lubricate, suppress dust, and cool the cold planer 100. In the same or other embodiments, some features of the cleaning system 200 may also exist and operate independently of any dust suppression system, i.e. may be activated only when the cold planer 100 is not performing a milling operation. No limitations are intended herein for complimentary functionality of the cleaning system 200, and any such functionality or associated processes will not be a focus of the present disclosure.

With continued reference to FIG. 3, the spray banks 220 may further include an undercarriage spray bank 232 located beneath the frame 110 and configured to clean the undercarriage 111; an anti-slab spray bank 234 located beneath the transition area 155, proximate to the anti-slab 180, and configured to clean the anti-slab 180; and/or one or more locomotive spray banks 240 located beneath the frame 110, proximate to each ground engaging member 131, and configured to clean each ground engaging member 131.

With reference to FIG. 2, the spray banks 220 may further include a moldboard spray bank 236 located proximate to the moldboard 141 and configured to clean the moldboard 141; and a side plate spray bank 238 located proximate to the side plate 142 and configured to clean the side plate 142. In various embodiments, the moldboard spray bank 236 may be located inside or outside the drum housing 140 and may be configured to clean an inside and/or an outside of the moldboard 141, depending on specific applicational requirements. Similarly, the side plate spray bank 238 may be located inside or outside the drum housing 140 and may be configured to clean an inside and/or an outside of the side plate 142. It may be understood that one or more spray banks 220 may overlap and/or that the same spray bank 220 may be associated with multiple components.

As shown in FIG. 3, in other possible embodiments, the spray banks 220 may further include an external intermediate spray bank 242 located beneath the intermediate stage conveyor 160 and configured to clean an exterior and/or a bottom surface of the intermediate stage conveyor 160; a final frame spray bank 244 located above the final stage conveyor frame 175 and configured to clean the final stage conveyor frame 175; and an external frame spray bank 246 located external to the frame 110 and configured to clean an exterior or outer surface of the cold planer 100.

It may be appreciated that the illustrated placement of each spray bank 220 is for descriptive purposes only, and that other locations and orientations for each spray bank 220 are also possible and envisioned. In various embodiments, the cleaning system 200 may include yet additional spray banks 220, each being configured to target and clean one or more components of the cold planer 100. No limitation is intended herein for the number or placement of additional spray banks 220, which may depend on the configuration of the cold planer 100 and specific applicational requirements.

Returning now to FIG. 4, in an embodiment, each spray bank 220 in the cleaning system 200 may include one or more nozzles 2201 and a hydraulic control valve 2202. For each spray bank 220, the type, size, and number of nozzles 2201 may depend on an overall size of the spray bank 220 and the size, geometry, and/or expected soil level of its associated component. In an embodiment, each set of nozzles 2201 may be fluidly connected in parallel along a spray manifold (not shown), although other arrangements are also possible without limitation.

Likewise, the hydraulic control valve 2202 for each spray bank 220 may be selected based on the pressure and/or flowrate requirements for each spray bank 220. In some embodiments, the hydraulic control valve 2202 may be controllable to operatively adjust at least a duration and a pressure and/or flowrate through its respective spray bank 220. In the same or other embodiments, each hydraulic control valve may be responsive to a signal from the electronic controller 299. Accordingly, the electronic controller 299 may operatively control both the pump 212 and each hydraulic control valve 2202 to control and activation and to adjust the duration and the pressure and/or flowrate through each spray bank 220.

In some embodiments, the cleaning system 200 may further include one or more actuators 293 associated with one or more spray banks 220. Each actuator 293 may be configured to adjust a spray vector of the associated spray bank 220 and/or nozzle(s) 2201 therein. Each actuator 293 may be independently and operatively controlled by the electronic controller 299 and may be aimed as dictated by a given cleaning program. No limitations are intended herein for the type or number of actuators 293, nor the degrees of freedom and range they may provide. By adjusting the spray vector(s) to be directed at specific areas of each component, the actuators 293 may improve an efficiency and an efficacy of their respective spray bank(s) 220.

With continued reference to FIG. 4, the cleaning system 200 may further include an air jet assembly 250 configured to blast the cold planer 100 with air before and/or after the milling operation. For example, the air jet assembly 250 may be activated for preliminary dusting prior to activation of any spray banks 220, and/or the air jet assembly 250 may be activated post spray bank 220 activation to dry and/or provide supplementary cleaning functionality. The air jet assembly 250 may include a pneumatic pump 251 fluidly coupled to an air inlet (not shown) and fluidly coupled to one or more air jets 260. The pneumatic pump 251 may operatively affect a pressure and/or a mass flowrate supplied to each air jet 260 and may be operatively controlled by the electronic controller 299.

Each of the air jets 260 may be associated with one or more spray banks 220 of the spray assembly 210. As seen in FIG. 3, the air jets 260 may specifically include a first milling drum jet 262 associated with the first milling drum spray bank 222, a second milling drum jet 264 associate with the second milling drum spray bank 224, a transition jet 266 associated with the transition spray bank 226, an intermediate jet 268 associated with the intermediate spray bank 228, and/or a final jet 270 associated with the final spray bank 230. In some embodiments, each air jet 260 may be placed proximate to its associated spray bank 220, may be associated with the same component as said spray bank 220, and may be configured and oriented to maximally dry or clean the associated component.

The air jets 260 may further include an undercarriage jet 272 associated with the undercarriage spray bank 232, an anti-slab jet 274 associated with the anti-slab spray bank 234, and/or one or more locomotive jets 280 associated with the one or more locomotive spray banks 240.

As shown in FIG. 2, the air jets 260 may further include a moldboard jet 276 associated with the moldboard spray bank 236, and a side plate jet 278 associated with the side plate spray bank 238, And in yet other possible embodiments seen in FIG. 3, the air jets 260 may include an external intermediate jet 282 associated with the external intermediate spray bank 242, a final frame jet 284 associated with the final frame spray bank 244, and/or an external frame jet 286 associated with the external frame spray bank 246.

It may be understood that one or more air jets 260 may be associated with the same spray bank 220, that one or more spray banks 220 may be associated with the same air jet 260, that a spray bank 220 may be implemented without an associated air jet 260, and/or that an air jet 260 may be implemented without an associated spray bank 220. The cleaning system 200 may include additional air jets 260 not mentioned herein but nonetheless embodied within the present disclosure. The number, type, and placement of each air jet 260 may depend on the configuration of the cold planer 100, the number and placement of spray banks 220, and specific applicational requirements for the cleaning programs.

In an embodiment, each air jet 260 in the cleaning system 200 may include one or more nozzles 2601 and a pneumatic control valve 2602. For each air jet 260, the type, size, and number of nozzles 2601 may depend on an overall size of the air jet 260 and the parameters of its associated spray bank 220 or associated component. The pneumatic control valve 2602 for each air jet 260 may be selected based on the pressure and/or mass flowrate requirements for each air jet 260. In some embodiments, the pneumatic control valve 2602 may be controllable to operatively activate each air jet 260 and to operatively adjust at least a duration and the pressure and/or mass flowrate. In the same or other embodiments, each pneumatic control valve 2602 may be responsive to a signal from the electronic controller 299. Accordingly, the electronic controller 299 may operatively control both the pneumatic pump 251 and each pneumatic control valve 2602 to adjust an activation and the duration and the pressure and/or mass flowrate through each air jet 260.

In some embodiments, the cleaning system 200 may further include one or more actuators 295 associated with the one or more air jets 260. Each actuator 295 may be configured to adjust a stream vector of the associated air jet 260 and/or nozzle(s) 2601 therein. Each actuator 295 may be independently and operatively controlled by the electronic controller 299 and may be aimed as dictated by a given cleaning program. No limitations are intended herein for the type or number of actuators 295, nor the degrees of freedom and range they may provide.

With continued reference to FIG. 4, the cleaning system 200 may also include a sensor assembly 291 configured to detect debris on the cold planer 100. The sensor assembly 291 may include one or more sensors 298 associated with one or more spray banks 220 of the spray assembly 210 and/or one or more components of the cold planer 100. Further, each sensor 298 may be in operative communication with the electronic controller 299. A soil level detected by each sensor 298 may be relayed to the electronic controller 299 prior to or during a cleaning program. In some embodiments, the electronic controller 299 may operatively control the pump 212 and each hydraulic control valve 2202 according to the soil level detected by each sensor 298. In the same or other embodiments, the electronic controller 299 may operatively control the pneumatic pump 251 and each pneumatic control valve 2602 according to the soil level detected by each sensor 298.

It may be understood that one or more sensors 298 may be associated with the same spray bank 220, that one or more spray banks 220 may be associated with the same sensor 298, and/or that a spray bank 220 may be implemented without an associated sensor 298. In some embodiments, each sensor 298 may employ a machine vision and/or artificial intelligence software to optically estimate a soil level of its associated component. In other embodiments, each sensor 298 may measure particulate matter in its vicinity. No limitation is intended herein for the number, type, or placement of each sensor 298, which may depend on the configuration of the cold planer 100, the placement of associated spray banks 220, and applicational requirements for the cleaning programs.

The electronic controller 299 may include at least a central processing unit (CPU), a memory in the form of a non-transitory computer-readable medium, and a communication unit configured to receive inputs from the sensor assembly 291 and to output commands to the spray assembly 210 and the air jet assembly 250. The controller 299 may be embodied in, without limitation, a microcontroller, an engine control unit (ECU), a field-programmable gate array (FPGA), an application-specific integrated circuit (ASIC), an onboard computer, and/or other comparable devices known to the art. In some embodiments, the electronic controller 299 may be embodied in and/or share computing resources with other management or computing devices on the cold planer 100.

### INDUSTRIAL APPLICATION

The present disclosure may find industrial applicability toward a number of cold planers and milling machines; and may be implemented to efficiently and consistently clean such machines before and/or after milling operations. Accordingly, the disclosed embodiments may potentially improve an operating efficiency of the machine, reduce labor costs, and reduce component depreciation.

The present disclosure may be applied to any number of cold planers utilized in landscaping, construction, road paving, asphalt reclamation, and related industries. Said machines may be categorized within any class of cold planing as recognized under the Federal Highway Administration, and may work with any type or number of materials, working depths, and milling projects, where no limitations are intended by the present disclosure.

The cleaning systems and methods herein may be performed to clean the cold planer before or after a milling operation. If performed before, the disclosed systems and methods may reduce the subsequent buildup of debris, and especially prevent dirt deposition around moving components, such as the milling drum, intermediate conveyor, and final conveyor. Other components adjacent to and/or affected by milled material, such as the drum housing, anti-slab, side plate, undercarriage, locomotive device, and others, may also be cleaned and prepped for smooth operation. Accordingly, an efficiency during milling may be improved, a chance of malfunction decreased, and an overall component life extended. If performed after the milling operation, the disclosed systems and methods may likewise remove debris from key components and reduce component depreciation from rust and oxidation. Cleaning the cold planer after each use may also prepare the machine for subsequent operations or even periods of dormancy.

The disclosed system and methods may offer improved cleaning penetration, improved consistency, decreased water usage, and greater efficiency and/or speed when compared to existing methods, such as those requiring worker participation. In some embodiments, worker participation may be entirely avoided or at least minimized, thereby reducing labor costs and also sources of human error. Moreover, the disclosed cleaning system may include versatile cleaning programs which can be fine-tuned to the needs of each machine and use case.

In some embodiments, an existing cold planer may be retrofitted and reprogrammed with the systems and methods of the present disclosure. For example, some cold planers may include hydraulic systems and spray assemblies designed for dust suppression, lubrication, cooling, and the like during milling operations. Said assemblies may be easily redirected to assist the cleaning functionalities disclosed herein. In some embodiments, additional hardware such as the jet assembly, sensor assembly, and/or actuators of the present disclosure may be installed on existing cold planers at minimal cost. And in the same or other embodiments, existing controllers or management devices may be installed with software to implement the cleaning programs of the present disclosure. Advantageously, the present disclosure may utilize any existing hardware and computing resources without limitation to facilitate implementation of the disclosed cleaning system.

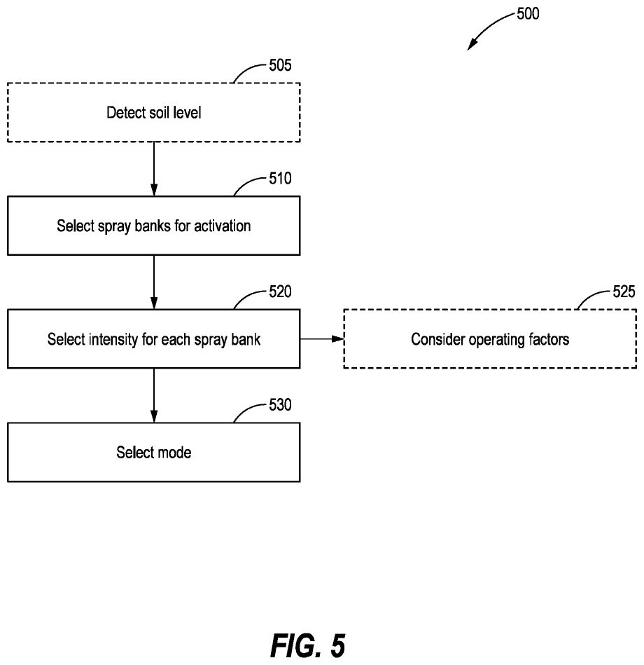

Turning now to FIG. 5, a method of programming a cleaning program for cleaning a cold planer before or after a milling operation is generally referred to by a reference numeral 500. The method 500 may comprise selecting one or more spray banks for activation (block 510), selecting an intensity for each activated spray bank (block 520), and selecting a mode (530), each step of which will be discussed in greater detail below.

In bock 510, one or more spray banks are selected for activation. The spray banks may be selected from among a first milling drum spray bank, a second milling drum spray bank, a transition spray bank, an intermediate spray bank, and a final spray bank. In some embodiments, the selected spray banks may further include an undercarriage spray bank, a moldboard spray bank, a side plate spray bank, an anti-slab spray bank, and/or a locomotive spray bank. In the same or other embodiments, the one or more spray banks may include an exterior intermediate spray bank, a final frame spray bank, and/or an external frame spay bank. And in yet other embodiments, additional spray banks may be activated depending on the number installed on the cold planer and specific applicational requirements, where no limitation is intended by the present disclosure. Not all installed spray banks need be selected and, if selected, the activated spray banks need not be activated concurrently during the cleaning program.

In block 520, an intensity is selected for each activated spray bank. For the purposes of this disclosure, the intensity may be a unitless parameter indicative of a desired depth of cleaning. For example, the intensity may be measured as a percentage, where a lower percentage may be indicative of light cleaning when the soil level is expected to be low and a higher percentage may be indicative of a deep cleaning when the soil level is expected to be high. Accordingly, the selected intensity may affect a duration and a pressure and/or flowrate through each selected spray bank for activation. It may be understood that the intensity selected for each spray bank will not necessarily be the same.

In some embodiments, block 520 may further include considering one or more operating factors of the cold planer (block 525). In an embodiment, if the cleaning program is to be selected after a milling operation, block 525 may include factoring in one or more of a type of the milling operation, a duration of the milling operation, a depth of the milling operation, an energy consumption of the milling operation, and/or a milled material of the milling operation. Each of the aforementioned factors may impact the soil level and the distribution of debris found on the components of the cold planer, and may thus be used to predict an intensity of cleaning desired for each component. The intensity or relative intensity of each selected spray bank may accordingly differ. Additional factors may be considered when selecting the intensity, where no limitation is intended herein for their type or number. Likewise, no limitations are intended for the specific algorithms by which the intensity may be calculated from the considered factors. In some embodiments, the aforementioned factors may be manually considered by a human operator and, in other embodiments, may be automatically derived from onboard sensors and/or management systems.

In some embodiments, the cold planer may comprise a sensor assembly including one or more sensors configured to detect debris. Each sensor may be associated with one or more spray banks and one or more components of the cold planer. In such embodiments, the method 500 may further comprise detecting a soil level on the components using the one or more sensors (block 505).

In a first embodiment, the sensors may detect a soil level to inform which spray banks are selected for activation (block 510). For example, a threshold soil level may be programmed to determine if cleaning is necessary for any given component. In the same or other embodiments, the detected soil level may also be factored into the intensity selection (block 520). For example, a lower soil level may result in a lower intensity being selected and a higher soil level may result in a higher intensity being selected for the associated spray bank. It may be understood that not all spray bank activations (block 510) may rely on the sensors and/or that not all spray bank intensity selections (block 520) may rely on the sensors. Moreover, no limitations are intended for the specific algorithms by which the intensity may be derived from detected soil levels.

In block 530, a mode is selected. In an embodiment, the mode may be a water-saving mode, a deep-cleaning mode, or a quick-cleaning mode. For example, the water-saving mode may be optimized to reduce water consumption, the deep-cleaning mode may be optimized for maximum debris removal, and the quick-cleaning mode may be optimized for efficient or quick cleaning. Accordingly, the mode may impact the duration, pressure, and flowrate of the activated spray banks. For example, the water-saving mode may reduce the duration and/or flowrate of water to each spray bank, the deep-cleaning mode may increase duration and water pressure to each spray bank, and the quick-cleaning mode may reduce duration and increase water pressure to each spray bank. In other embodiments, the aforementioned modes may be programmed with other outputs and additional modes are also possible and envisioned. In some embodiments, the selected mode may be universally applied to all activated spray banks.

In some embodiments, the spray bank selection (block 510), the intensity selection (block 520), and the mode selection (block 530) are incorporated in a function which decides the duration and the pressure and/or flowrate supplied to each spray bank. For example, the mode may decide a baseline duration, pressure, and/or flowrate, and the intensity may act as a unitless multiplier on some or all of the baseline outputs. The algorithms by which the duration and pressure and/or flowrate is calculated may be determined by specific applicational requirements, where no limitations are intended herein.

In an embodiment, one or more steps of the method 500 may be manually inputted by a human operator. For example, the operator may select which spray banks to be activated, the intensity for each or all activated spray banks, and the cleaning mode via a control panel, human machine interface, or related input mechanism. The input mechanism may operatively communicate with the electronic controller and may be located on the cold planer, such as in an operator cabin. Alternatively, the input mechanism may be located external to the cold planer, such as in a central management station, and inputs may be remotely communicated to the electronic controller.

In another embodiment, one or more steps of the method may be automatically performed by the electronic controller. For example, the electronic controller may automatically determine which spray banks to activate, the intensity of each spray bank, and the cleaning mode based on information from onboard sensors and/or control systems, such as the sensor assembly or ECU.

And in yet other embodiments, the method 500 may be operatively performed by a combination of operator inputs and automatic determinations. In some embodiments, preset cleaning programs may be programmed into the electronic controller, such as by a manufacturer, supplier, or the like. In such embodiments, an operator may simply select a preset cleaning program from those available via the control panel or alternative input mechanism.

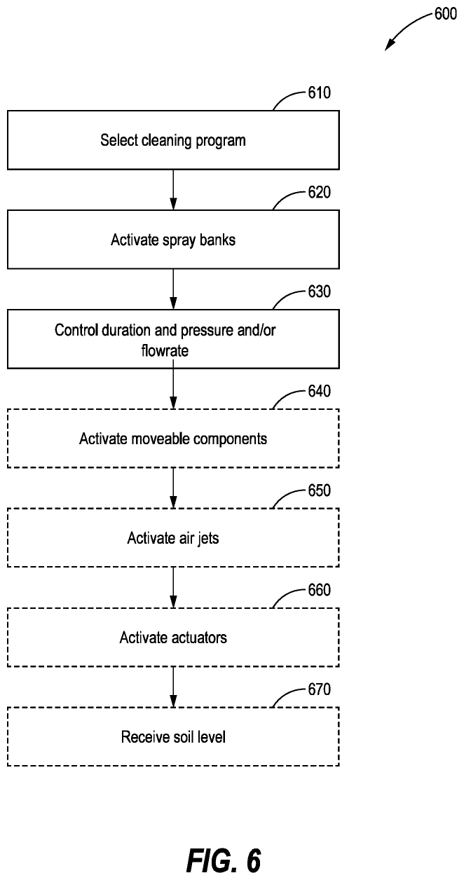

It may be appreciated that the steps of method 600 may be performed in a different order than the one shown in FIG. 6, that one or more steps may be omitted, and/or that one or more steps may be performed in parallel.

Turning now to FIG. 6, a method of cleaning a cold planer before or after a milling operation is generally referred to by a reference numeral 600. The method 600 may comprise selecting a cleaning program (block 610), activating one or more spray banks based on the cleaning program (block 620), and controlling a duration and a pressure and/or flowrate through each activated spray bank based on the cleaning program (block 630). In some embodiments, the method 600 may further comprise activating one or more moveable components associated with the one or more activated spray banks (block 640), activating one or more air jets associated with the one or more spray banks (block 650), activating one or more actuators associated with the one or more spray banks (block 660), and/or receiving a soil level from one or more sensors associated with the one or more spray banks (block 670).

In block 610, a cleaning program is selected. The cleaning program may be selected according to the method 500 of the present disclosure and may include the selection of spray banks for activation, an intensity for each activated spray bank, and a mode for the cleaning program. However, other implementations of block 610 are also possible and envisioned. In various examples, the cleaning program may be inputted by an operator; automatically determined by an electronic controller; or even preprogrammed by a manufacturer, supplier, or operator.

In block 620, one or more spray banks are activated and, in block 630, a duration and a pressure and/or flowrate through each spray bank are controlled. As previously discussed with respect to the method 500, not all spray banks are necessarily activated and the water level or relative water level supplied to each spray bank may vary, based on the selected cleaning program.

In an embodiment, the cold planer may comprise a reservoir, a hydraulic pump configured to operatively supply water from the reservoir to each spray bank, and one or more hydraulic control valves, each hydraulic control valve being associated with a spray bank. Accordingly, block 620 may be implemented by controlling the hydraulic pump and by controlling each hydraulic control valve, i.e. to activate or deactivate an associated spray bank. Likewise, block 630 may be implemented by controlling the hydraulic pump and by controlling each hydraulic control valve to adjust a duration and a pressure and/or flowrate through each hydraulic control valve.

In block 640, one or more moveable components may be activated. In an embodiment, the moveable components may include a milling drum, an intermediate stage conveyor, and a final stage conveyor of the cold planer. For example, if a milling drum spray bank is activated, the milling drum may also be operated to improve an exposure to the cleansing spray. In another example, the intermediate spray bank and/or final stage spray bank may be activated and the intermediate stage conveyor and/or the final stage conveyor also be operated, respectively, to improve exposure. In some embodiments, a duration and a speed of each moveable component may be adjusted based on the cleaning program. For example, the above components may be operated at a lower speed or RPM from their standard milling parameters and/or may be run in reverse. It may be understood that activation of the moveable components may not necessarily rely on activation of an associated spray bank. Moreover, activation of each moveable component may occur before or after activation of the spray banks, may not occur concurrently with one another, and may have variable speed over time. Other moveable components in addition to the foregoing are also possible and envisioned, and may depend on the configuration of the cold planer and applicational requirements of the cleaning program.

In block 650, one or more air jets are activated and, in some embodiments, a duration and a pressure and/or mass flowrate through each air jet are controlled. Each air jet may be associated with one or more spray banks and may be configured to blast the cold planer with air, e.g. for preliminary cleaning, drying, or related purposes. In various embodiments, not all air jets provided on the cold planer may be activated, not all air jets associated with activated spray banks may be activated, and air jets not associated with activated spray banks may also be activated. Moreover, activation of each air jet may occur before or after activation of the spray banks and may not occur concurrently with one another.

In an embodiment, the cold planer may comprise a pneumatic pump configured to operatively supply pressurized air to each air jet, and one or more pneumatic control valves, each hydraulic control valve being associated with an air jet. Accordingly, block 650 may be implemented by controlling the pneumatic pump and by controlling each pneumatic control valve, i.e. to activate or deactivate an associated air jet or to control a duration and a pressure and/or mass flowrate through each hydraulic control valve.

In block 660, one or more actuators may be activated. Each actuator may be associated with a spray bank and may be configured to adjust a spray vector of the spray bank. In an embodiment, activation of the actuators may occur before or during activation of the spray banks in block 620 and block 630, respectively. It may be understood that not all actuators associated with activated spray banks may be activated, and that different actuators may be controlled independently. Activation of the actuators may be configured such that each associated spray bank can better target specific areas of the cold planer, thereby improving cleaning efficacy.

In block 670, a soil level is received from one or more sensors. Each sensor may be associated with one or more spray banks and may be configured to detect debris on an associated component of the cold planer. In various embodiments, not all sensors provided for debris detection may be utilized, not all sensors associated with activated spray banks may be utilized, and sensors not associated with activated spray banks may also be activated as well.

In an embodiment, soil level detection may occur before, after, or concurrently with block 620 and block 630 of the method 600. Furthermore, the duration and the pressure and/or flowrate through each hydraulic control valve may be adjusted based on the detected soil level of the associated component. For example, the activation of one or more spray banks may be shortened or extended if the soil level detected by the associated sensor is low or high, respectively. Similarly, the pressure and/or flowrate through one or more spray banks may be decreased or increased as a function of the detected soil level. It may be understood that different spray banks may be adjusted independently as a function of their associated sensors. In some embodiments, the sensors may be utilized in an open-loop or closed-loop feedback system. In other words, sensor feedback may be constantly supplied and analyzed to control the activation and water output from each spray bank, where no limitations are intended for the specific control algorithms being employed.

It may be appreciated that the steps of method 600 may be performed in a different order than the one shown in FIG. 6, that one or more steps may be omitted, and/or that one or more steps may be performed in parallel.

In some embodiments, some or all steps of the method 600 may be operatively performed by an electronic controller. Accordingly, the electronic controller may operatively activate each spray bank; control the hydraulic pump and each hydraulic control valves to adjust a water flow from each spray bank; activate each moveable component and adjust their speed or direction; activate each air jet; control the pneumatic pump and each pneumatic control valve; activate each actuator; receive data from the sensor assembly; and/or implement feedback mechanisms. Moreover, the electronic controller may receive inputs from an operator (if applicable); receive data from the sensors; and supply control signals to each of the aforementioned components in order to effect the cleaning program 600.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

1. A cold planer comprising:
a frame;
a power unit being supported by the frame;
a drum housing being supported by the frame;
a milling drum enclosed in the drum housing and including a plurality of cutting elements;
a locomotive assembly supporting the frame;
an intermediate stage conveyor;
a final stage conveyor; and
a spray assembly configured to clean the cold planer before or after a milling operation, the spray assembly including:
a reservoir;
a pump;
a milling drum spray bank configured to clean the milling drum;
a transition spray bank configured to clean a transition area;
an intermediate spray bank configured to clean the intermediate stage conveyor;
a final spray bank configured to clean the final stage conveyor; and
an electronic controller configured to operatively control the pump and an activation of each spray bank.

2. The cold planer according to claim 1, further comprising an air jet assembly configured to blast the cold planer before or after the milling operation, the air jet assembly including one or more air jets associated with one or more spray banks of the spray assembly, wherein an activation of each air jet is operatively controlled by the electronic controller.

3. The cold planer according to claim 1, each spray bank of the spray assembly further including:
one or more nozzles; and
a hydraulic control valve;
wherein the electronic controller operatively controls the pump and each hydraulic control valve to adjust a duration and a pressure and/or a flowrate through each spray bank according to a cleaning program.

4. The cold planer according to claim 3, further comprising a sensor assembly configured to detect debris on the cold planer, the sensor assembly including one or more sensors associated with one or more spray banks of the spray assembly, wherein each sensor operatively communicates with the electronic controller.

5. The cold planer according to claim 1, further comprising:
an undercarriage located beneath the frame;
an anti-slab located beneath the transition area;
a moldboard located on the drum housing; and
a side plate located on the drum housing;
wherein the spray assembly further includes:
an undercarriage spray bank configured to clean the undercarriage;
an anti-slab spray bank configured to clean the anti-slab;
a moldboard spray bank configured to clean the moldboard;
a side plate spray bank configured to clean the side plate; and
a locomotive spray bank configured to clean the locomotive assembly.

6. The cold planer according to claim 1, the spray assembly further including:
an external intermediate spray bank configured to clean an exterior of the intermediate stage conveyor;
a final frame spray bank configured to clean a final stage conveyor frame; and
an external frame spray bank configured to clean an exterior of the frame.

7. The cold planer according to claim 3, the spray assembly further including one or more actuators associated with one or more spray banks and configured to adjust a spray vector of each associated spray bank, wherein each actuator is operatively controlled by the electronic controller.

8. The cold planer according to claim 4, wherein the electronic controller operatively controls the pump and each hydraulic control valve according to a soil level detected by each sensor of the sensor assembly.

9. A method of programming a cleaning program for cleaning a cold planer before or after a milling operation, the method comprising the steps of:
selecting one or more spray banks for activation;
selecting an intensity for each activated spray bank; and
selecting a mode.

10. The method according to claim 9, wherein the one or more spray banks for activation include:
a milling drum spray bank;
a transition spray bank;
an intermediate spray bank; and/or
a final spray bank.

11. The method according to claim 10, wherein the one or more spray banks for activation further include:
an undercarriage spray bank;
an anti-slab spray bank;
a moldboard spray bank;
a side plate spray bank; and/or
a locomotive spray bank.

12. The method according to claim 9, wherein the step of selecting the intensity further includes factoring in one or more of the following:
a type of the milling operation;
a duration of the milling operation;
a depth of the milling operation;
an energy consumption of the milling operation; and/or
a milled material of the milling operation.

13. The method according to claim 9, further comprising:
detecting a soil level using one or more sensors associated with the one or more spray banks.

14. The method according to claim 9, wherein the mode is selected from the group consisting of a water-saving mode, a deep-cleaning mode, or a quick-cleaning mode.

15. The method according to claim 9, wherein one or more steps of the method are automatically performed by an electronic controller.

16. A method of cleaning a cold planer before or after a milling operation, comprising the steps of:
selecting a cleaning program;
activating one or more spray banks based on the cleaning program; and
controlling a duration and a pressure and/or a flowrate through each activated spray bank based on the cleaning program
wherein one or more steps of the method are operatively performed by an electronic controller.

17. The method according to claim 16, further comprising:
activating one or more moveable components associated with the one or more spray banks, wherein the moveable components include a milling drum, an intermediate stage conveyor, and a final stage conveyor.

18. The method according to claim 16, further comprising:
activating one or more air jets associated with the one or more spray banks, the one or more air jets being configured to blast the cold planer with air.

19. The method according to claim 16, further comprising:
controlling one or more hydraulic control valves, each hydraulic control valve being associated with a spray bank;
controlling a hydraulic pump configured to operatively supply water from a reservoir to each spray bank; and
adjusting a duration and a pressure and/or flowrate through each hydraulic control valve based on the cleaning program.

20. The method according to claim 19, further comprising:
receiving a soil level from one or more sensors associated with the one or more spray banks, the sensors being configured to detect debris on the cold planer; and
adjusting the duration and the pressure and/or the flowrate through each hydraulic control valve based on the soil level.
